(19) United States
(12) Patent Application Publication
(10) Pub. No.: US 2026/0042982 A1
(43) Pub. Date: Feb. 12, 2026

(54) LIQUID BEER CONCENTRATE

(71) Applicant: HEINEKEN SUPPLY CHAIN B.V., Zoeterwoude (NL)

(72) Inventors: Augustinus Cornelius Aldegonde Petrus Albert BEKKERS, Zoeterwoude (NL); Eric Richard BROUWER, Zoeterwoude (NL)

(21) Appl. No.: 19/066,700

(22) Filed: Feb. 28, 2025

Related U.S. Application Data
(63) Continuation of application No. PCT/EP2023/073139, filed on Aug. 23, 2023.

(30) Foreign Application Priority Data
Sep. 2, 2022 (EP) 22193726.1

(51) Int. Cl. C12C 5/02; B67D 1/00; C12C 11/11

(52) U.S. Cl. CPC C12C 5/02; B67D 1/0021; C12C 11/11

(57) ABSTRACT

A liquid beer concentrate is disclosed having a water content of 25-90 wt. %, a carbohydrate content of 5-50 wt. %, a protein content of 1-6 wt. % and an ethanol content of 0-50 wt. %, and comprising 0.01-1.5 g/L of dissolved ascorbate. It was discovered that the development of off-flavour notes and/or haze formation in the liquid beer concentrate can be prevented or at least minimised by adding a small amount of ascorbate.

### CROSS-REFERENCE TO RELATED APPLICATIONS

This application is a continuation of International Patent Application No. PCT/EP2023/073139 filed Aug. 23, 2023, which claims priority to European Patent Application No. 22193726.1 filed Sep. 2, 2022, the entire disclosures of which are incorporated by reference herein.

### TECHNICAL FIELD OF THE INVENTION

The present invention relates to liquid beer concentrates that can suitably be used in the preparation of a high quality reconstituted beer. More particularly, the invention relates to a liquid beer concentrate having a water content of 25-90 wt. %, a carbohydrate content of 5-50 wt. %, a protein content of 1-6 wt. % and an ethanol content of 0-50 wt. %, said liquid beer concentrate comprising 0.01-1.5 g/L of dissolved ascorbate.

### BACKGROUND OF THE INVENTION

The popularity of domestic appliances for preparing and dispensing carbonated beverages from concentrated syrup, such as Sodastream®, has grown rapidly. These appliances produce carbonated beverages by carbonating water and mixing the carbonated water with a flavoured syrup. Given the high flexibility and convenience provided by these appliances, it is desirable to have available beer concentrates from which beer can be produced using similar appliances.

Since beer typically contains more than 90% of water, beer can be concentrated considerably by removing most of the water. The benefits of producing beer from a concentrate have been recognized in the art. However, the production of a good quality beer concentrate represents a challenging task. For instance, due to the high solute concentrations, it is very difficult to prepare a beer concentrate that does not exhibit significant instability (e.g. haze formation or flavour changes) during normal shelf-life.

WO 2017/167865 concerns a single-serve container comprising a malt based beverage concentrate or fermented beverage concentrate, characterized in that said concentrate is in a liquid state, has a dynamic viscosity of maximally 40.10³ mPa·s; a real extract density of at least 2.6° P; and an alcohol content of at least 1 vol %.

WO 2021/228871 describes a single-serve capsule comprising at least two compartments, including a first compartment and a second compartment; wherein the first compartment comprises a concentrate of an alcohol-free beer, said liquid beer concentrate having an ethanol content of 0-1% alcohol by volume (ABV); and wherein the second compartment comprises an alcoholic liquid containing 12-100 wt. % ethanol and 0-88 wt. % water, and wherein ethanol and water together constitute 80-100 wt. % of the alcoholic liquid.

US 2006/0286207 describes a malt-based or hops-based beverage product comprising:
a) a hops-based or malt-based beverage base; and
b) stabilizing mixture comprising:
   from about 0.000001% to about 0.2% of a metal, in the form of ions, salts, oxides, complexes, chelates or nonionic forms, selected from zinc, magnesium, calcium, chromium, copper, iron, selenium, manganese, and combinations thereof; and
   from about 0.01% to about 2.5% of an adjunct component selected from ascorbic acid, erythorbic acid, sugar alcohols, ascorbates, erythorbates, and combinations thereof.

US2016/346760A1 describes an oxygen-scavenging polymer comprising a hydrophobic polymer and an oxygen scavenger. The US patent application further describes method for preparing a beverage comprising the steps of:
a) providing an apparatus comprising a container, the oxygen-scavenging polymer and at least one beverage component, and
b) diluting the beverage component with a liquid to prepare a beverage.

US2016/222332A1 describes a method for preparing a beverage by mixing a base liquid with an ingredient and dispensing the beverage. Examples include mixing concentrated beer with hop concentrates, fruit concentrates, spices, flavour ingredients and foaming promoter.

CZ10769U1 relates to aqueous or aqueous-alcoholic concentrates or beverages comprising, among others, containing 0.01-5.0 vol. % of natural compounds from the group of vegetable acids, such as fruit acids, in particular citric, malic, succinic, ascorbic and tartaric acids and mixtures thereof.

### SUMMARY OF THE INVENTION

The inventors have observed that during storage, liquid beer concentrates tend to develop a haze and/or off-flavour notes that have been described as “aniseed” and “estery”. It is not known at present which components cause this haze formation or which compounds are responsible for this off-flavour note. Surprisingly, however, the inventors have discovered that the development of haze and/or the aforementioned off-flavour notes can be prevented or at least minimised by adding a small amount of ascorbate to the beer concentrate.

Thus, one aspect of the invention relates to a liquid beer concentrate having a water content of 25-90 wt. %, a carbohydrate content of 5-50 wt. %, a protein content of 1-6 wt. % and an ethanol content of 0-50 wt. %, said liquid beer concentrate comprising 0.01-1.5 g/L of dissolved ascorbate.

The invention also provides a process of preparing a liquid beer concentrate according to the invention, said process comprising:
providing a beer;
reducing the water content of the beer by means of membrane separation and/or freeze concentration to produce a liquid beer concentrate, wherein membrane separation is selected from nanofiltration, reverse osmosis and forward osmosis;
adding a source of ascorbate.

The present invention also provides a single-serve capsule comprising at least two compartments, including a first compartment and a second compartment; wherein the first compartment comprises a liquid beer concentrate according to the invention and wherein the second compartment comprises an alcoholic liquid, said alcoholic liquid containing at least 30 wt. % ethanol and not more than 65 wt. % water.

The present invention also relates to a method for preparing a beverage, said method comprising:
providing a liquid beer concentrate according to the invention.
diluting the liquid beer concentrate 3-10 times with carbonated water.

Finally, the present invention relates to the use of ascorbate to reduce formation of off-flavour and/or haze in a liquid beer concentrate, wherein ascorbate is added to said liquid beer concentrate in an amount of 0.01-1.5 g/L.

### DETAILED DESCRIPTION OF THE INVENTION

A first aspect of the invention relates to a liquid beer concentrate having a water content of 25-90 wt. %, a carbohydrate content of 5-50 wt. %, a protein content of 1-6 wt. % and an ethanol content of 0-50 wt. %, said liquid beer concentrate comprising 0.01-1.5 g/L of dissolved ascorbate.

The term “beer” as used herein refers to a yeast fermented malt beverage that has optionally been hopped. Beer is commonly produced by a process that comprises the following basic steps:
mashing a mixture comprising malted barley, optionally supplementary grains and water to produce a mash;
separating the mash in wort and spent grains;
boiling the wort to produce a boiled wort;
fermenting the boiled wort with live yeast to produce a fermented wort;
subjecting the fermented wort to one or more further process steps (e.g. maturation and filtration) to produce beer; and
packaging the beer in a sealed container, e.g. a bottle, can or keg.

Hop or hop extract is usually added during wort boiling to produce hopped beer. Depending on the beer style and brewing facility, the employed hopping method and timing may vary.

The term “beer concentrate” as used herein refers to beer from which water has been removed, e.g. by means of nanofiltration, reverse osmosis, forward osmosis and/or freeze concentration.

The term “ascorbate” as used herein encompasses the compound ascorbic acid as well as dissociated forms of ascorbic acid (e.g. dissociated ascorbic acid or dissociated ascorbate salts).

The term protein as used herein refers to a polypeptide comprising a chain of at least 20 amino acid residues.

The term “membrane separation” as used herein refers to a separation method in which molecules are separated by passing a feed stream through a membrane that separates it into two individual streams, known as the permeate and the retentate. Examples of membrane separation include nanofiltration, reverse osmosis and forward osmosis.

The term “iso-alpha acids” as used herein refers to substances selected from the group of isohumulone, isoadhumulone, isocohumulone, pre-isohumulone, post-isohumulone and combinations thereof. The term “iso-alpha acids” encompasses different stereo-isomers (cis-iso-alpha acids and trans-iso-alpha acids). Iso-alpha acids are typically produced in beer from the addition of hops to the boiling wort. They may also be introduced into the beer in the form of pre-isomerised hop extract. Iso-alpha-acids are intensely bitter with an estimated threshold value in water of approximately 6 ppm.

The term “hydrogenated iso-alpha acids” refers to substances selected from dihydro-iso-alpha acids, tetrahydro-iso-alpha acids, hexahydro-iso-alpha acid and combinations thereof.

The term “hulupones” as used herein refers to substances selected from cohulupone, n-hulupone, adhulupone, hydrogenated versions of these substances and combinations thereof. Hulupones are oxidation products of hop beta-acids.

The term “capsule” as used herein refers to a compartmentalized container suitable for separately holding the two liquid components according to the invention.

The term “single-serve” as used herein is a synonym of “monoportion” or “unit dose” and refers to a capsule comprising sufficient amounts of beer concentrate and alcoholic liquid to prepare one serving of reconstituted beer. Typically, one serving of reconstituted beer is in the range of 120 ml to 1000 ml.

The term “added” as used herein refers to compounds that do not originate from the beer from which the concentrate is derived.

The liquid beer concentrate of the present invention preferably has a water content of 30-85 wt. %, more preferably the liquid beer concentrate has a water content of 35-80 wt. %, most preferably the liquid beer concentrate has a water content of 40-75 wt. %.

The carbohydrate content of the liquid beer concentrate preferably is in the range of 8-45 wt. %, more preferably in the range of 10-40 wt. % and most preferably in the range of 11-35 wt. %.

The liquid beer concentrate typically contains starch hydrolysis products in the forms of sugars and oligosaccharides. These starch hydrolysis products are formed during mashing. The so-called fermentable sugars, which, depending on the yeast that is employed, include glucose, maltose and maltotriose, may be digested by yeast during fermentation.

Unlike the sugars maltose and maltotriose, maltotetraose is not significant digested by most brewer's yeasts. Consequently, the concentration of maltotetraose is usually hardly affected by yeast fermentation. The liquid beer concentrate preferably contains 10-100 g/L, more preferably 12-80 g/L, even more preferably 15-60 and most preferably 18-40 g/L of maltotetraose.

In one embodiment of the present invention the liquid beer concentrate is a concentrate of an alcohol-free beer that has been produced by dealcoholisation of an alcoholic beer. The liquid beer concentrate according this embodiment typically contains only a limited amount of maltose and/or maltotriose.

Preferably, the liquid beer concentrate of de-alcoholised beer contains maltose in a concentration of 0-20 g/L, more preferably of 0.2-15 g/L, even more preferably of 0.3-10 g/L and most preferably of 0.5-8 g/L.

The liquid beer concentrate of de-alcoholised beer preferably contains maltotriose in a concentration of 1-30 g/L, more preferably of 2-25 g/L, even more preferably of 2.5-22 g/L and most preferably of 3-20 g/L.

In another embodiment of the present invention the liquid beer concentrate is a concentrate of an alcohol-free beer that has been produced using a fermentation method that produces virtually no ethanol (ethanol restricted fermentation). The liquid beer concentrate according this embodiment typically contains relatively high levels of maltose and/or maltotriose.

The liquid beer concentrate according to this embodiment preferably contains maltose in a concentration of 60-400 g/L, more preferably of 90-300 g/L, even more preferably of 120-280 g/L and most preferably of 150-250 g/L.

The liquid beer concentrate obtained from alcohol-free beer that has been produced using an ethanol restricted fermentation preferably contains maltotriose in a concentration of 30-150 g/L, more preferably of 40-120 g/L, even more preferably of 45-110 g/L and most preferably of 50-100 g/L.

The protein content of the liquid beer concentrate preferably is in the range of 1.2-5.5 wt. %, more preferably in the range of 1.4-5.0 wt. % and most preferably in the range of 1.5-4.5 wt. %.

The combination of water and ethanol preferably constitutes at least 50 wt. %, more preferably 55-90 wt. % and most preferably 60-88 wt. % of the liquid beer concentrate.

Preferably, water, carbohydrate, protein and ethanol together constitute at least 90 wt. %, more preferably at least 92 wt. % and most preferably 94-99.5 wt. % of the liquid beer concentrate.

The liquid beer concentrate preferably comprises 0.05-1.3 g/L dissolved ascorbate, more preferably the liquid beer concentrate comprises 0.075-1.2 g/L dissolved ascorbate, most preferably the liquid beer concentrate comprises 0.1-1.1 g/l dissolved ascorbate.

In a preferred embodiment the liquid beer concentrate is a concentrate of a pale lager.

In one embodiment of the present invention the liquid beer concentrate is an alcoholic beer concentrate that can be reconstituted with carbonated water to produce an alcoholic beer. The liquid beer concentrate according to this embodiment, preferably has ethanol content of 10-50% ABV, more preferably 12-45% ABV and most preferably 15-40% ABV.

The alcoholic beer concentrate preferably contains 50-1,000 mg/L, more preferably 60-800 mg/L, most preferably 70-400 mg/L of hop acids selected from iso-alpha acids, hydrogenated alpha-acids, hulupones and combinations thereof.

In an alternative embodiment, the liquid beer concentrate is a low alcohol beer concentrate. The liquid beer concentrate according to this embodiment preferably has an ethanol content of 0-5% ABV, more preferably of 0-2% ABV, even more preferably of 0-1% ABV, and most preferably of 0-0.5% ABV.

The low alcohol beer concentrate preferably contains 0-20 mg/L, more preferably 0-10 mg/L, most preferably 0-3 mg/L of hop acids selected from iso-alpha acids, hydrogenated alpha-acids, hulupones and combinations thereof.

The pH of the liquid beer concentrate is preferably in the range of 3.0 to 6.0, more preferably in the range of 3.2 to 5.5 and most preferably in the range of 3.5-5.0.

The riboflavin content of the liquid beer concentrate is preferably in the range of 250-3,000 μg/L more preferably 300-2,500 μg/L, more preferably 350-2,200 μg/L and most preferably 400-2,000 μg/L.

The liquid beer concentrate preferably contain 150-5,000 μg/L, more preferably 200-4,000 μg/L, even more preferably 250-3,500 μg/L and most preferably 300-3,000 μg/L of linoleic acid. Besides linoleic acid, the liquid beer concentrate typically also contains other fatty acids, such as oleic acid and/or alpha-linolenic acids. Oleic acid is preferably present in the liquid beer concentrate in a concentration of 300-3,000 μg/L, more preferably 400-2,500 μg/L, even more preferably 500-2,000 μg/L and most preferably 600-1,800 μg/L.

Alpha-linolenic acid is preferably present in the liquid beer concentrate in a concentration of 100-1,200 μg/L, more preferably 120-1,100 μg/L, even more preferably 150-1,000 μg/L and most preferably 180-900 μg/L.

Preferably, the liquid beer concentrate does not contain any added metal selected from zinc, magnesium, calcium, chromium, copper, iron, selenium or magnesium, more preferably the liquid beer concentrate does not contain any added metal other than alkali metals, most preferably the liquid beer concentrate does not contain any added metal.

Preferably, the liquid beer concentrate does not contain any added catalase, more preferably the liquid beer concentrate does not contain any added enzyme.

Preferably, the liquid beer concentrate does not contain any added citric acid or added citrate.

In a preferred embodiment the liquid beer concentrate does not contain added phytate or added phytic acid.

The liquid beer concentrate preferably does not comprise an infusion of capsicum, more preferably the liquid beer concentrate does not comprise an infusion of fruit, most preferably the liquid beer concentrate does not comprise any infusion.

In a particular preferred embodiment, the liquid beer concentrate does not comprise any added substances besides ascorbate.

Another aspect of the invention relates to a process of producing a liquid beer concentrate, said process comprising:
providing a beer;
reducing the water content of the beer by means of membrane separation and/or freeze concentration to produce a liquid beer concentrate, wherein the membrane separation is selected from nanofiltration, reverse osmosis and forward osmosis;
adding a source of ascorbate.

In a preferred embodiment the source of ascorbate comprises, calculated by weight of dry matter, 50-100 wt. % ascorbate, preferably the ascorbate comprises 80-100 wt. % ascorbate. An aqueous solution of ascorbate may suitably be employed as a source of ascorbate in the present process.

Preferably, the beer provided in the process according to the invention has an ethanol content 0-12% ABV, more preferably of 0-8% ABV, even more preferably of 0-2% ABV, most preferably of 0-1% ABV.

In one embodiment, the beer provided is an alcohol-free beer that has been produced by dealcoholisation of an alcoholic beer.

In another embodiment, the beer provided is obtained by cold contact fermentation.

In a preferred embodiment, the beer provided contains 0-5 mg/L of hop acids per gram of dry matter, said hop acids being selected from iso-alpha acids, hydrogenated iso-alpha acids, hulupones and combinations thereof.

In a preferred embodiment the water content is reduced by reversed osmosis.

In another preferred embodiment the water content is reduced by freeze concentration.

Another aspect of the invention relates to a single-serve capsule comprising at least two compartments, including a first compartment and a second compartment; wherein the first compartment comprises a liquid beer concentrate according to the invention and wherein the second compartment comprises an alcoholic liquid, said alcoholic liquid containing at least 30 wt. % ethanol and not more than 65 wt. % water.

The single serve capsule of the present invention may comprise two or more compartments. Most preferably, the capsule contains two compartments, one comprising the liquid beer concentrate, the other comprising the alcoholic liquid.

In accordance with a preferred embodiment, the at least two compartments are separated by separating wall and closed by a sealed foil or a lid.

Preferably the first compartment of the single serve capsule contains 10-60 mL, more preferably 15-50 mL, most preferably 20-40 mL of the liquid beer concentrate.

The second compartment of the single serve capsule preferably contains 4-25 mL, more preferably 6-20 mL, most preferably 7-15 mL of the alcoholic liquid.

The combined internal volume of the first compartment and the second compartment preferably does not exceed 75 mL, more preferably it is in the range of 15-65 mL, most preferably in the range of 20-60 mL.

The liquid beer concentrate and the alcoholic liquid are preferably contained in the capsule in a weight ratio of 7:1 to 1:1, more preferably in a weight ratio of 6:1 to 1.2:1, most preferably in a weight ratio of 5:1 to 1.5:1.

In a preferred embodiment, the alcoholic liquid contains 13-90 wt. % ethanol and 10-87 wt. % water, more preferably the alcoholic liquid contains 25-85 wt. % ethanol and 15-75 wt. % water, more preferably the alcoholic liquid contains 40-82 wt. % ethanol and 18-60 wt. % water.

Preferably, water and ethanol together constitute 85-100 wt. %, more preferably 90-100 wt. % and most preferably 95-100 wt. % of the alcoholic liquid.

The alcoholic liquid preferably contains 30-2,000 mg/L of hop acids being selected from iso-alpha acids, hydrogenated iso-alpha acids, hulupones and combinations thereof, wherein ethanol and water together constitute at least 90 wt. % of the alcoholic liquid. More preferably, the alcoholic liquid comprises 50-1,800 mg/L, more preferably 100-1,500 mg/L, most preferably 200-1,000 mg/L of hop acids.

The alcoholic liquid that is employed in the present capsule may suitably comprise ethanol that is obtained from de-alcoholisation of alcoholic beer. Vacuum distillation is commonly used to remove alcohol from beer. The distillate so obtained contains ethanol, water as well as a range of volatile beer flavour substances. Such distillates may advantageously be applied in the alcoholic liquid of the present capsule, especially if the liquid beer concentrate was produced from de-alcoholised beer. The term “vacuum distillation” as used herein also encompasses “vacuum evaporation”.

Accordingly, in a preferred embodiment, the alcoholic liquid comprises a distillate obtained by distillative de-alcoholisation of an alcohol-containing beer. Most preferably, the alcoholic liquid consists of such a distillate or is an aqueous dilution of such a distillate.

Preferably, the alcoholic liquid comprises, per kg of ethanol, 50-2,000 mg, more preferably 70-1,500 mg, even more preferably 90-1,200 mg and most preferably 100-800 mg of ethyl acetate.

Preferably, the alcoholic liquid comprises, per kg of ethanol, 5-200 mg, more preferably 7-150 mg, even more preferably 9-120 mg and most preferably 10-80 mg of isoamyl acetate.

In a preferred embodiment the alcoholic liquid contains, per kg of ethanol, 400-5,000 mg, more preferably 600-4,000 mg, even more preferably 700-3,500 mg and most preferably 800-3,00 mg of amyl alcohols. Here the term “amyl alcohols” refers to alcohols with the formula C₅H₁₂O.

In another preferred embodiment the alcoholic liquid contains, per kg of ethanol, 8-240 mg, more preferably 11-170 mg, even more preferably 13-140 mg and most preferably 15-100 mg of phenylethyl alcohol.

Preferably, the alcoholic liquid contains, per kg of ethanol, 2-50 mg, more preferably 3-40 mg, even more preferably 3.5-32 mg and most preferably 4-25 mg of phenyl ethyl acetate.

Another aspect of the invention relates to a method for preparing beer from the liquid beer concentrate according to the invention, said method comprising: μproviding a liquid beer concentrate according to the invention; μdiluting the liquid beer concentrate 3-10 times, preferably 3.5-8 times with carbonated water.

In a preferred embodiment the liquid beer concentrate is provided by a single serve capsule as described herein before, and the method comprises: μintroducing the single serve capsule into a beverage preparation device; μreleasing the liquid beer concentrate from the first compartment; μreleasing the alcoholic liquid from the second compartment; μcombining the released liquid beer concentrate, the released alcoholic liquid, water and carbon dioxide to produce an alcoholic beer; μdispensing the alcoholic beer.

The release of the liquid beer concentrate and the alcoholic liquid may occur simultaneously or sequentially, in whatever order.

Also the combining of the released liquid beer concentrate, the released alcoholic liquid, water and carbon dioxide can be done in different manners.

In one preferred embodiment, first water and carbon dioxide are admixed to produce carbonated water, after which the carbonated water is mixed with the released alcoholic liquid to produce and alcoholic carbonated aqueous liquid that is finally mixed with the released liquid beer concentrate.

In another preferred embodiment, first water and the released alcoholic liquid are admixed to produce a dilute alcoholic liquid, after which carbon dioxide is admixed to produce an alcoholic carbonated aqueous liquid that is finally mixed with the released liquid beer concentrate.

In yet another preferred embodiment, water, carbon dioxide and the released alcoholic liquid are mixed in a single step to produce an alcoholic carbonated aqueous liquid, followed by the admixture of the released liquid beer concentrate.

Preferably, the carbonated water contains 1-8 g/L, more preferably 2-7 g/L dissolved carbon dioxide.

Another aspect of the invention relates to the use ascorbate to reduce the formation of off-flavour and/or haze in liquid beer concentrates, wherein ascorbate is added to said liquid beer concentrate in an amount of 0.01-1.5 g/L.

The invention is further illustrated by the following non-limiting examples.

### EXAMPLES

### Example 1

A beer concentrate was produced from a commercially available lager beer (5% ABV) using freeze concentration.

The beer concentrate so obtained was divided in three equal portions. A small, identical amount of water or aqueous solution of ascorbic acid was added to each of the portions, resulting in the ascorbic acid concentrations that are mentioned in Table 1.

TABLE 1

| | Amount of ascorbic acid added |
|---|---|
| | (g/L) |
| Beer concentrate A | 0.00 |
| Beer concentrate 1 | 0.42 |
| Beer concentrate 2 | 1.04 |

The beer concentrates as well as the original beer were evaluated by an expert panel before and after having been stored for 1 month at 20 degrees Celsius. Immediately before evaluation, the beer concentrates were reconstituted by combining 60 mL of concentrate with carbonated water having a temperature of 0-4° C. to a final volume of 250 mL.

The original beer and reconstituted beers were rated on a scale of 5.5 to 7.0. The results of the panel evaluation are summarised in Table 2.

TABLE 2

Storage time (in months)

| | 0 | 1 |
|---|---|---|
| Original beer | 6.8 | 6.7 |
| Beer concentrate A | 6.6 | 6.4 |
| Beer concentrate 1 | 6.6 | 6.6 |
| Beer concentrate 2 | 6.6 | 6.6 |

The panellists noted that after 1 month storage, beer concentrate A had developed an off-flavour note that was described as “aniseed”.

### Example 2

The experiment of Example 1 was repeated, except that this time a different commercial beer was used. The results of the panel evaluation are summarised in Table 3.

TABLE 3

Storage time (in months)

| | 0 | 1 |
|---|---|---|
| Original beer | 6.6 | 6.5 |
| Beer concentrate A | 6.5 | 6.3 |
| Beer concentrate 1 | 6.5 | 6.4 |
| Beer concentrate 2 | 6.5 | 6.4 |

The panellists noted that after 1 month storage, beer concentrate A had developed an off-flavour note that was described as “estery”.

### Example 3

A non-hopped lager (containing 5% ABV was de-alcoholised by vacuum distillation (Schmidt-Bretten, Bretten, Germany—feed: 5 hL/hr; steam mass flow rate: 100 kg/h; outlet pressure: 3.5 bar; vacuum setting: 90 mbar; outlet temperature: 3°° C.). The resulting de-alcoholised beer had an ethanol content of 0.01% ABV.

The dealcoholized non-hopped lager was concentrated by means of nanofiltration using the following set-up:

### Nanofiltration Membrane

| | |
|---|---|
| Type | Configuration: Spiral wound |
| | Membrane polymer: Composite polyamide |
| | Brine spacer material: Polypropylene |
| Specifications | Permeate Flow: |
| | MgSO₄: 7.6 m³/d |
| | NaCl: 9.5 m³/d |
| | Stabilised salt rejection¹: |
| | MgSO₄: >97% (2000 ppm, 4.8 bar, |
| | 25° C., 15% recovery, pH 6.5) |
| | NaCl: 89-95% (500 ppm, 4.8 bar, 25° C., |
| | 15% recovery, pH 7.0) |
| | Nominal membrane area: 7.9 m² |

¹Equates to a MW cut-off of appr. 200 Da

A (total length)=1016 mm
B (ATD diameter)=100.3 mm
C (connection diameter)=19.1 mm
D_{F} (core tube extension−feed side)=26.7 mm
D_{C} (core tube extension−conc. side)=26.7 mm

### Maximum Operating Limits

Pressure: 80 bar
Temperature: 28° C.
Pressure drop: 0.7 bar
Feed flow: 3.6 m³/h
Chlorine concentration: <0.1 ppm
Feed water SDI (15 min.): 5.0
Feed water turbidity: 1.0 NTU
Feed water pH: 3.0-10.0
Maximum ratio of concentrate to permeate flow for any element: 5:1

### Filtration Run

Circulation of the beer was effected by a piston pump. This pump has a capacity of 1 m³/h and a maximum discharge pressure of 20-80 bar. The test-unit was limited to approximately 30 bar and was protected by means of an overpressure relief valve having a set-point of 40 bar.

Initial permeate production started at a pressure of around 15 bar (osmotic pressure).

In total 100 litres of beer were filtered, yielding 84.6 litres of permeate and 16.1 litres of liquid concentrate. Consequently, the concentration factor achieved was 100/15.4=6.5.

The composition of the beer concentrate so obtained is shown in Table 4.

TABLE 4

| | | |
|---|---|---|
| Acetic acid | 310 | mg/L |
| Riboflavin | 890 | μg/L |
| Oleic acid | 1040 | μg/L |
| Linoleic acid | 980 | μg/L |
| Alpha-linolenic acid | 630 | μg/L |
| Free amino nitrogen | 310 | mg/L |
| Maltose | 1.1 | g/L |
| Maltotriose | 7.0 | g/L |
| Maltotetraose | 22 | g/L |

The beer concentrate so obtained is divided in two equal portions. A small, identical amount of water or aqueous solution of ascorbic acid is added to each of the portions, resulting in the ascorbic acid concentrations that are mentioned in Table 5.

TABLE 5

| | Amount of ascorbic acid added |
|---|---|
| | (g/L) |
| Beer concentrate A | 0.00 |
| Beer concentrate 1 | 1.50 |

The beer concentrate as well as the original beer are evaluated by an expert panel before and after having been stored for 1 month at 20° C. Immediately before evaluation, the beer concentrates are reconstituted by combining 33 mL of concentrate with carbonated water having a temperature of 0-4° C. to a final volume of 200 mL.

The evaluation by the expert panel shows that the beer concentrate containing added ascorbic acid was more stable than the beer concentrate that did not contain added ascorbic acid.

### Example 4

A beer concentrate (20% ABV) was produced from a lager beer (7% ABV) using freeze concentration.

The beer concentrate so obtained was divided in two equal portions. To one portion ascorbic acid was added in a concentration of 1.0 g/L (Beer concentrate 1). The other portion (Beer concentrate A) served as a control.

Beers were prepared from these beer concentrates by combining 60 mL of concentrate with carbonated water having a temperature of 0-4° C. to a final volume of 250 mL. The reconstituted beers were prepared shortly after production of the beer concentrates, after 1 and 3 months storage of the concentrates at 30° C., and after 6 months storage at 4° C.

Turbidity of the beer concentrates, the reconstituted beers and the original beer (i.e. the beer before concentration) was measured. The turbidity of the reconstituted beers was measured shortly after reconstitution.

Turbidity was measured at a scattering angle of 90°, at a temperature of 0° C., and at a wavelength of 650 nm. Results are in Tables 6a and 6b.

TABLE 6a

Storage time at 30° C. (months)

| | 0 | 1 | 3 |
|---|---|---|---|
| Original beer | 0.3 | n.a. | 0.3 |
| Beer concentrate A | 8.4 | 22.4 | 47.8 |
| Beer concentrate 1 | 4.9 | 10.4 | 18.1 |
| Beer from concentrate A | 0.3 | 2.3 | 4.1 |
| Beer from concentrate 1 | 0.3 | 0.8 | 0.9 |

TABLE 6b

Storage time at 4° C. (months)

| | 0 | 6 |
|---|---|---|
| Original beer | 0.3 | n.a. |
| Beer concentrate A | 8.4 | 15.8 |
| Beer concentrate 1 | 4.9 | 9 |
| Beer from concentrate A | 0.3 | 2.4 |
| Beer from concentrate 1 | 0.3 | 1.3 |

The beers prepared from concentrates A and 1, as well as the original beer (i.e. the beer before concentration) were also evaluated by an expert panel before and after having been stored for 3 months at 30 degrees Celsius for 3 months. The beers were rated on a scale of 5.5 to 7.0. The results of the panel evaluation are summarised in Table 7.

TABLE 7

Storage time at 30° C. (months)

| | 0 | 3 |
|---|---|---|
| Original beer | 6.7 | 6.5 |
| Beer from concentrate A | 6.8 | 6.0 |
| Beer from concentrate 1 | 6.5 | 6.4 |

1. A liquid beer concentrate having a water content of 25-90 wt. %, a carbohydrate content of 5-50 wt. %, a protein content of 1-6 wt. % and an ethanol content of 0-50 wt. %, the liquid beer concentrate comprising 0.01-1.5 g/L of dissolved ascorbate.

2. The liquid beer concentrate according to claim 1, wherein the liquid beer concentrate comprises 0.05-1.3 g/l of dissolved ascorbate.

3. The liquid beer concentrate according to claim 1, wherein water, carbohydrate, protein and ethanol together constitute at least 80 wt. % of the liquid beer concentrate.

4. The liquid beer concentrate according to claim 1, wherein the liquid beer concentrate has a riboflavin content in the range of 250-3,000 μg/L.

5. The liquid beer concentrate according to claim 1, wherein the liquid beer concentrate has an ethanol content of 0-1% ABV.

6. The liquid beer concentrate according to claim 5, wherein the liquid beer concentrate comprises 0-20 mg/L of hop acids per gram of dry matter, the hop acids being selected from iso-alpha acids, hydrogenated iso-alpha acids, hulupones and combinations thereof.

7. The liquid beer concentrate according to claim 1, wherein the liquid beer concentrate has an ethanol content of 10-50% ABV.

8. The liquid beer concentrate according to claim 7, wherein the liquid beer concentrate comprises 50-1,000 mg/L of hop acids per gram of dry matter, the hop acids being selected from iso-alpha acids, hydrogenated iso-alpha acids, hulupones and combinations thereof.

9. A process for preparing a liquid beer concentrate according to claim 1, comprising:
(a) providing a beer;
(b) reducing the water content of the beer by membrane separation and/or freeze concentration to produce a liquid beer concentrate, wherein membrane separation is selected from nanofiltration, reverse osmosis and forward osmosis;
(c) adding a source of ascorbate.

10. The process according to claim 9, wherein the source of ascorbate comprises, calculated by weight of dry matter, 50-100 wt. % ascorbate.

11. The process according to claim 9, wherein the beer that is provided has an ethanol content of 0-1% ABV.

12. The process according to claim 11, wherein the beer contains 0-20 μg of hop acids per gram of dry matter, the hop acids being selected from iso-alpha acids, hydrogenated iso-alpha acids, hulupones and combinations thereof.

13. A single-serve capsule comprising at least two compartments, including a first compartment and a second compartment, wherein the first compartment comprises a liquid beer concentrate according to claim 1 and wherein the second compartment comprises an alcoholic liquid, the alcoholic liquid comprising at least 30 wt. % ethanol and not more than 65 wt. % water.

14. A method for preparing a beverage, comprising:
(a) providing a liquid beer concentrate according to claim 1;
(b) diluting the liquid beer concentrate 3-10 times with carbonated water.

15. A method of reducing formation of off-flavour and/or haze in a liquid beer concentrate, comprising adding ascorbate to the liquid beer concentrate in an amount of 0.01-1.5 g/L.
